(19) United States
(12) Patent Application Publication
(10) Pub. No.: US 2013/0048782 A1
(43) Pub. Date: Feb. 28, 2013

(54) APPARATUS AND METHOD FOR MEASURING AN AIR PRESSURE AND SYSTEM FOR DETECTING AIR DATA

(71) Applicants: AIRBUS OPERATIONS GMBH, Hamburg (DE); AIRBUS SAS, Blagnac (FR)

(72) Inventors: Carsten Bohlen, Cornebarrieu (FR); Holger Bohlen, Delmenhorst (DE); Carsten Blunck, Wedel (DE); Jean Cammas, Toulouse (FR)

(73) Assignees: AIRBUS SAS, Blagnac (FR); AIRBUS OPERATIONS GMBH, Hamburg (DE)

(21) Appl. No.: 13/660,216

(22) Filed: Oct. 25, 2012

Related U.S. Application Data
(63) Continuation of application No. PCT/EP2011/056527, filed on Apr. 26, 2011.
(60) Provisional application No. 61/328,778, filed on Apr. 28, 2010.

(30) Foreign Application Priority Data
Apr. 28, 2010 (DE) 10 2010 018 547.7

(51) Int. Cl. G01L 19/00; B64C 5/06; B64D 3/00

(52) U.S. Cl. 244/1 TD; 73/714

(57) ABSTRACT

An apparatus for measuring an air pressure includes a linear retaining means, a towed device, at least one pressure sensor for acquiring a static pressure, and an actuating device that can be positioned in an aircraft, for retracting and extending the linear retaining means. The towed device includes an enclosure, an autarchic voltage supply and a wireless first communication device that is connected to the autarchic voltage supply. The first communication device is equipped to transmit signals and/or data that represent acquired measurement data to a second communication device. Consequently, the linear retaining means can be attuned purely to the task of retaining the towed device and does not need to carry out any secondary tasks of transmitting signals and/or measured data.

### CROSS-REFERENCE TO RELATED APPLICATIONS

The present application is a continuation of International Application No. PCT/EP2011/056527, filed Apr. 26, 2011, which claims priority from U.S. Provisional Patent Application No. 61/328,778, filed on Apr. 28, 2010, and German Patent Application No. 10 2010 018 547.7, filed on Apr. 28, 2010, the disclosures of which are hereby incorporated herein by reference.

### TECHNICAL FIELD

The invention relates to an apparatus for measuring an air pressure on an aircraft. The invention furthermore relates to a system for acquiring air data, to a method for measuring an air pressure, and to an aircraft comprising at least one device for measuring an air pressure.

### BACKGROUND OF THE INVENTION

Safe flight and proper operation of an aircraft make it indispensable on board the aircraft to regularly acquire essential air data, which, for example, also includes the static ambient pressure outside the aircraft. In order to fulfill this task, in the state of the art a host of various sensors exist which are, for example, arranged in close proximity to the outside of the aircraft. For the purpose of calibrating the anemometry and for re-gaining RVSM certification following structural repairs or the like, towed probes are temporarily used which are towed at a relatively large distance behind the aircraft in order to acquire air data with the least possible influence as a result of the aerodynamic flow around the aircraft. RVSM denotes “Reduced Vertical Separation Minimum”; it refers to reduced vertical separation which results in improved utilisation of airways.

Such towed sensors are well known from the state of the art; they include, for example, towed probes that can be guided by an air hose behind an aircraft and that, by means of a sensor arranged within the aircraft, with the use of the air hose can measure the ambient pressure in the region of the probe. Furthermore, directly-measuring towed sensors are also known which can be guided by a fibre optic line behind the aircraft, wherein the energy supply to the towed sensor is provided by transforming optical energy to electrical energy, and the sensor can communicate, by way of the fibre optic line with the aircraft or with an arithmetic unit arranged therein, for transmitting a measured value.

In the case of larger commercial aircraft, such towed sensors are frequently arranged on a vertical stabiliser so as to be extendable; they require a winding roll with a diameter significantly exceeding one metre, and thus conduit routing from the vertical stabiliser, which is normally not pressurised, to a pressurised region of an aircraft fuselage. This requires replacement of an end cap of the vertical stabiliser, a special ground test to determine the friction in the conduit, and re-painting of the end cap of the vertical stabiliser after deinstallation of the conduit.

DE 40 13 921 C1 shows apparatus for measuring the air pressure in the context of aircraft, which apparatus is designed as a towed system, wherein a fibre optic line is designed to act at the same time both as a retaining means for a towed sensor and as an energy transmission means for supplying the towed sensor.

### BRIEF SUMMARY OF THE INVENTION

The above-mentioned towed sensors from the state of the art are not entirely suitable to meet all the requirements relating to light weight, good reliability in the context of repeated extension and retraction, and to little space requirement in a deactivated, i.e. retracted, state.

An aspect of the present invention improves apparatus of the type mentioned above for measuring an air pressure in such a manner that the reliability can be improved while the weight and/or the installation space requirement can be reduced.

According to an exemplary embodiment, the apparatus according to the invention comprises a towed device with an enclosure, which towed device is connected to an actuating device by way of a linear retaining means. The actuating device is designed to be arranged in the aircraft, and by way of the linear retaining means to move the towed device relative to the aircraft in order to extend or retract said towed device in this manner.

In order to determine the static air pressure the apparatus according to an embodiment of the invention comprises at least one pressure sensor.

Furthermore, the towed device comprises an autarchic voltage supply device and a first communication device that is designed to transmit signals and/or data to a second communication device or to receive signals and/or data from said second communication device. The autarchic voltage supply device is connected to the first communication device, which in turn is designed to transmit measured data acquired by the sensor to the second communication device. The at least one pressure sensor is equipped to forward a determined static pressure to the first communication device.

In this arrangement the first communication device is designed as a wireless communication device which for communication does not require an electrically or optically conducting connection to the second communication device. For this purpose the first communication device comprises, for example, a modulator, an oscillation circuit and a transmitting and receiving antenna. It is understood that all suitable communication devices from the state of the art can be used for the transmission of data between the first communication device and the second communication device, including, for example, devices to improve reliability and/or data security, with such devices not being limited to analogue transmission mechanisms but in particular also mastering digital transmission mechanisms.

The apparatus according to an embodiment of the invention provides a special advantage in that transmission of the measured values relating to the static pressure between equipment in the towed device and the aircraft takes place independently of a mechanical connection between the towed device and the aircraft. Therefore this mechanical connection in the form of the linear retaining means can be attuned purely to the mechanical function of retaining the towed device. The linear retaining means used in the state of the art, for example a pressure hose or an optic fibre, are suited only to a limited extent to fulfilling this mechanical retaining function, because the primary functions consist of transmitting signals. There are other materials available to improve the retaining function. For example it would be advantageous to use wire cables or synthetic cables, for example comprising nylon or Kevlar of a particularly thin cross section, which cables not only feature very high tensile strength but at the same time are also particularly easily stowed away. In the case of thin wire cables or synthetic cables it is possible to achieve significantly smaller bending radii, which result in very easy stowability without negatively affecting the quality of physical signal transmission, which would be the case, for example, in a hose or an optical fibre as a result of excessive bending or buckling. The resulting small diameter of a winding roll or the like for taking up the linear retaining means can result in integration of the actuating device directly in a vertical stabiliser, and consequently it might thus be possible to do without conduit routing from a vertical stabiliser to a pressurised region of an aircraft.

Transmitting and receiving units that can wirelessly communicate with other transmitting and receiving units are presently already available in a greatly miniaturised form, so that the weight of the towed device is not determined to a significant extent by the first communication device, but instead to a large extent also by the pressure sensor itself. Furthermore, for example, batteries as autarchic voltage supplies are also available in greatly miniaturised form, for example in the form of high-performance lithium cells, wherein at the same time rechargeable batteries featuring a very good capacity-to-weight ratio also exist, for example lithium-polymer accumulators, which can practically be adapted to any desired design shape.

In a preferred embodiment the actuating device is designed as a winch that is equipped to retract or extend the linear retaining means, for example by rolling in or rolling out onto or from a reel or a winding roll.

In a particularly preferred embodiment the linear retaining means is designed as a nylon cable that comprises low density while at the same time providing very high tensile strength.

In a likewise preferred embodiment the linear retaining means is designed as at least one wire. If several wires are used they could be interconnected or twisted to form a wire cable.

Preferably, the enclosure of the towed device tapers off and at a thinner end comprises a device for connection to the linear retaining means. In operation this form is used to tension the linear retaining means, with the towed device attached to it, behind the aircraft as a result of the effect of the airflow, and to carry out an even straight-line movement.

In an exemplary embodiment of the invention the towed device comprises a solar cell as an autarchic voltage supply, which solar cell is arranged on the enclosure of the towed device and can be used in addition to a battery as an energy storage device or can be used independently thereof. Since calibration flights are mostly undertaken during daylight hours, a solar cell would be able to generate an adequate voltage that allows operation of the sensor.

In an exemplary embodiment of the invention the towed device additionally comprises a GPS receiver which transmits data by way of the transmitting and receiving unit. The GPS receiver can, in particular, be used for transmitting a geometric altitude, which makes possible the subsequent linking between a barometric altitude, determined by way of absolute pressure sensors, and the geometric altitude.

By linking the geometric altitude at the sensor position, the barometric altitude measured at the position of the towed vehicle, and the geometric altitude at a reference point of the aircraft, determined by means of an on-board GPS receiver, precise determination of the barometric altitude at an aircraft reference point can be undertaken. Any difference in altitude between the position of the towed vehicle and the position of the aircraft can thus be eliminated by correlating these various determined altitude values.

Other embodiments and aspect of the invention include a system for measuring air data, a method for measuring an air pressure, and an aircraft comprising apparatus for measuring an air pressure.

### BRIEF DESCRIPTION OF THE DRAWINGS

Further characteristics, advantages and application options of the present invention are disclosed in the following description of the exemplary embodiments and of the figures. All the described and/or illustrated characteristics per se and in any combination form the subject of the invention, even irrespective of their composition in individual claims or their interrelationships. Furthermore, identical or similar components in the figures have the same reference characters.

FIGS. 1a, 1b, 1c, 1d and 1e show a diagrammatic view of exemplary embodiments of apparatus according to an embodiment of the invention.

FIG. 2 shows a diagrammatic view of a system according to an embodiment of the invention.

FIG. 3 shows an aircraft equipped with at least one system according to an embodiment of the invention.

FIG. 4 shows a block diagram of a method according to an aspect of the invention.

### DETAILED DESCRIPTION

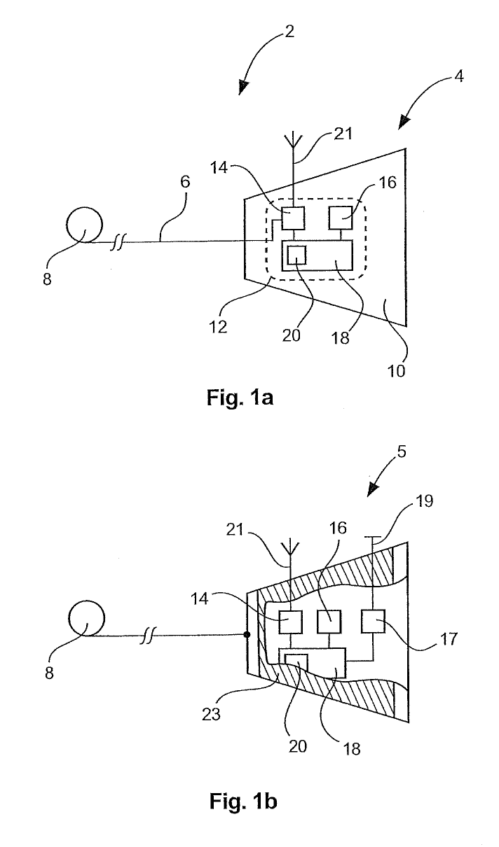

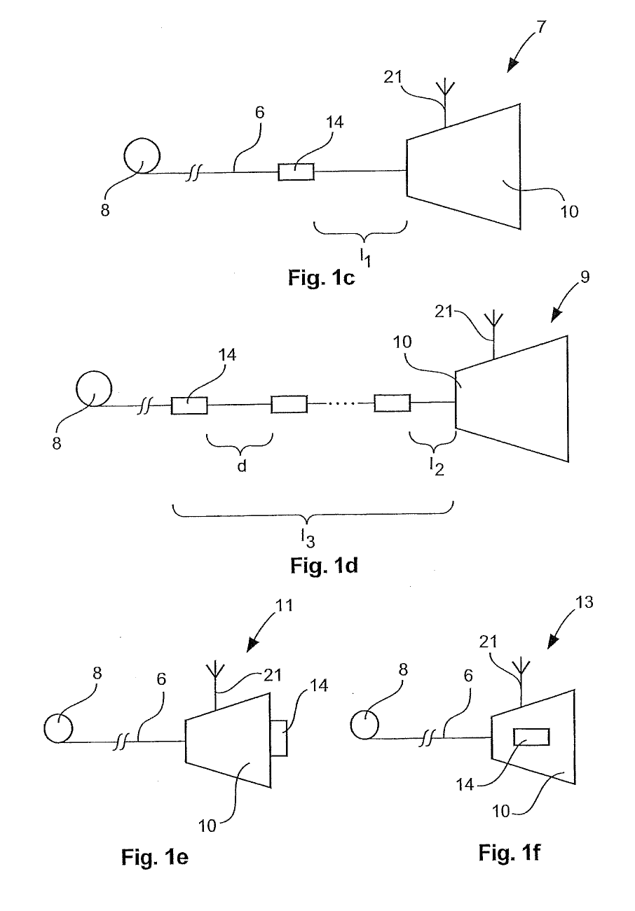

FIG. 1a shows apparatus 2 according to an embodiment of the invention, which apparatus 2 comprises a towed device 4, a linear retaining means 6 and an actuating device 8. In this arrangement the towed device 4 comprises an enclosure 10 which in order to protect against dirt, moisture and dynamic pressure encloses a grouped arrangement of electronic and mechanical devices 12. The term “towed device” 4 refers to the device, arranged on the retaining means 6, which is towed behind the aircraft. It is not imperative for this towed device 4 to comprise measuring devices as shown in the exemplary embodiments of FIGS. 1c and 1d.

In the towed device 4 a pressure sensor 14, an energy storage device 16 as an autarchic voltage supply, and a first communication device 18 that is connected both to the energy storage device 16 and to the pressure sensor 14 are arranged. Preferably, apart from the actual provisions necessary for communication, the first communication device also comprises an electronics unit 20 which processes signals or measured values of the pressure sensor 14 in such a manner that they can be transmitted in the form of data or signals to the outside to a further communication device.

Preferably, the first communication device 18 is a wireless communication device and is correspondingly connected to a transmitting and receiving antenna 21 that can be positioned at various positions inside or outside the enclosure 10. With corresponding dimensioning it would also be possible for the entire enclosure 10 to serve as an antenna for a predetermined narrow frequency range. On the other hand the antenna 21 could also be bonded in the shape of a wire or the like onto the outer surface of the enclosure 10, wherein corresponding insulation is to be affixed between the antenna 21 and the enclosure 10. As an alternative to this, the antenna 21 could also be designed so as to be rigid and could extend away from the enclosure or it could be implemented as a slack stranded wire, protruding from the enclosure 10, with a corresponding insulation sheath in the manner of a wire antenna. Without limiting the invention to this, the first communication device 18 can, for example, be designed to implement data transmission by means of a frequency-spreading method which is insensitive to narrow-band interference.

The linear retaining means 6 is used to pull the enclosure 10, together with the devices contained therein, behind an aircraft, wherein the linear retaining means 6 is exclusively equipped to exert a pulling force on the towed device 4, which pulling force results from the aerodynamic flow around the enclosure 10 and from the associated aerodynamic resistance or drag.

In the case depicted, the actuating device 8 is designed as a winch with a motorised winding roll or the like, which winding roll is equipped to roll in and roll out the linear retaining means 6 and in so doing to retract it from, or extend it to, an airstream present behind an aircraft. By means of rolling in and rolling out, the towed device 4 can be removed from the movement means 8 in order to, in this manner, be able to measure a static pressure, for example at a predetermined distance from an aircraft, for example at 1-1.5 times the aircraft length.

FIG. 1b shows a modified towed device 4 which in addition to the components shown in FIG. 1a also comprises a GPS receiver 17 that is connected to a GPS antenna 19 and to the first communication device 18. The GPS receiver 17 usually transmits GPS information at continuous intervals to the first communication device 18, which can use this information to transmit a geometric altitude to the aircraft, which geometric altitude has been determined by position finding. A barometric altitude determined in the aircraft can be correlated with the geographic altitude determined by position finding, or corresponding calibration of the barometric altitude display can be carried out.

In order to save additional weight, the GPS antenna 19 is preferably designed as a ceramic chip antenna, but it can at the same time also be designed as a separate antenna affixed to the enclosure 10, in particular if the enclosure 10 comprises a metallic material.

In addition to the above, the exemplary embodiment of FIG. 1b comprises a solar cell 23 as an autarchic voltage supply, which solar cell 23 could be arranged on the enclosure 12 and is connected to the first communication device 18. This can be in support of an energy storage device 16 which could be dimensioned so as to be correspondingly smaller, thus predominantly serving as a buffer storage device.

In the exemplary embodiment of FIG. 1c the pressure sensor 14 is not arranged within the enclosure 10 of a towed device 7, but instead, when seen upstream, is spaced apart from the enclosure 10 by a distance l₁ so as to be free of any aerodynamic influences of the enclosure 10. In this arrangement the pressure sensor 14 is preferably wired to the first communication device 18, which is located within the enclosure 10. If the retaining means 6 comprises a metallic material, it could be used as part of the wiring.

At the same time, according to FIG. 1d it is also possible to implement measuring a pressure gradient behind an aircraft in that a multitude of pressure sensors 14 are arranged, so as to be spaced apart from each other, on the retaining means 6 upstream of the enclosure 10 of a towed device 9. For example, the space d between the individual pressure sensors 14 is between 2 and 10 m, wherein the pressure sensors extend along a rear section of the retaining means 6, for example along a third. The overall length l₃ of this arrangement of pressure sensors 14 could, for example, be 50 m, with an overall length of the retaining means 6 of 150 m and a distance l₂ of, for example, less than 5 m from the enclosure 10.

In the design of such an exemplary embodiment a particularly flat and compact pressure sensors 14 may be used so that rolling-in the retaining means 6 is not negatively affected. Furthermore, the pressure sensors 14 must be wired to the first communication device 18 so that the determined measured values can be transmitted to the aircraft. This could take place by means of particularly fine wiring, wherein in the embodiment of the retaining means 6 as a thin wire cable the retaining means 6 could be used as a shared voltage supply terminal or the like for the pressure sensors 14.

FIGS. 1e and 1f show further different positions of a pressure sensor 14. FIG. 1e, for example, demonstrates a pressure sensor 14, arranged behind the enclosure 10, on a towed device 11, while in FIG. 1f the pressure sensor 14 is arranged on the outside of the enclosure 10 of a towed device 13.

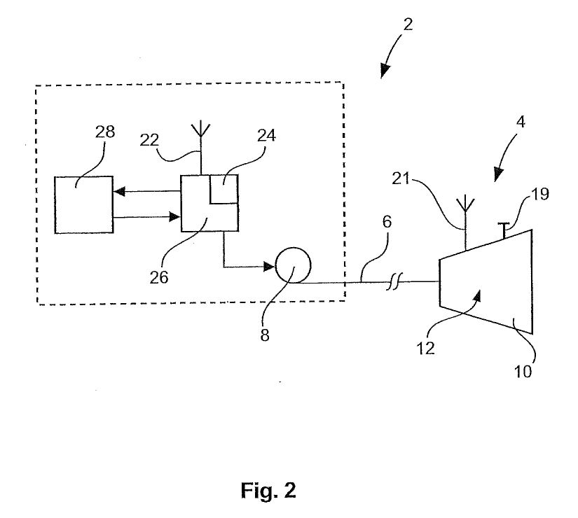

In a manner that differs from the above, FIG. 2 shows an overall system according to an embodiment of the present invention, which apart from the apparatus 2 also comprises a second communication device 24 with an antenna 22, furthermore also a regulating unit 26 that is designed to both control the actuating device 8 and to forward the data transmitted by the towed device 4 to at least one corresponding electronics device 28 within the aircraft. The second communication device 24 could preferably be equipped for initiating the communication with the first communication device 18 so that, in an existing connection, data is transmitted in packets to the second communication device 24.

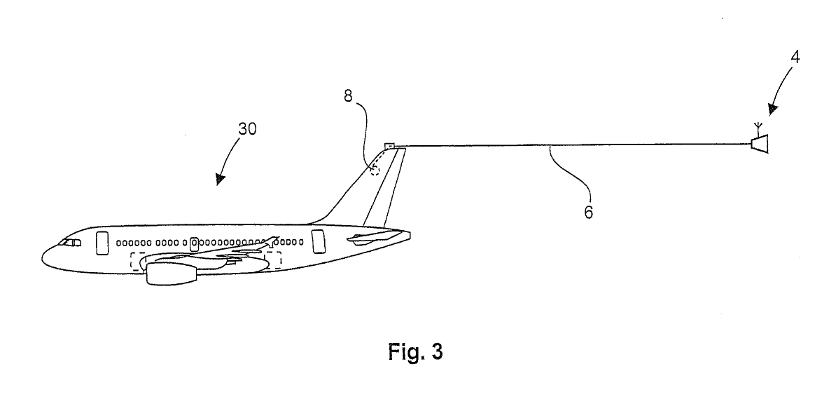

FIG. 3 shows an aircraft 30 with a system according to an embodiment of the invention, which system makes it possible for the aircraft 30 to extend the towed device 4 behind the aircraft 30 in order to determine a static air pressure in that location. The distance between the towed device 4 and the rear delimitation of the aircraft 30 could, for example, be 1-1.5 times the aircraft length. Preferably, the apparatus according to an embodiment of the invention is arranged in a vertical stabiliser, particularly preferably in a front spar of the vertical stabiliser and/or in an end cap of the vertical stabiliser, wherein the linear retaining means 6 could be fed through an opening at an upper region of the vertical stabiliser above the rudder.

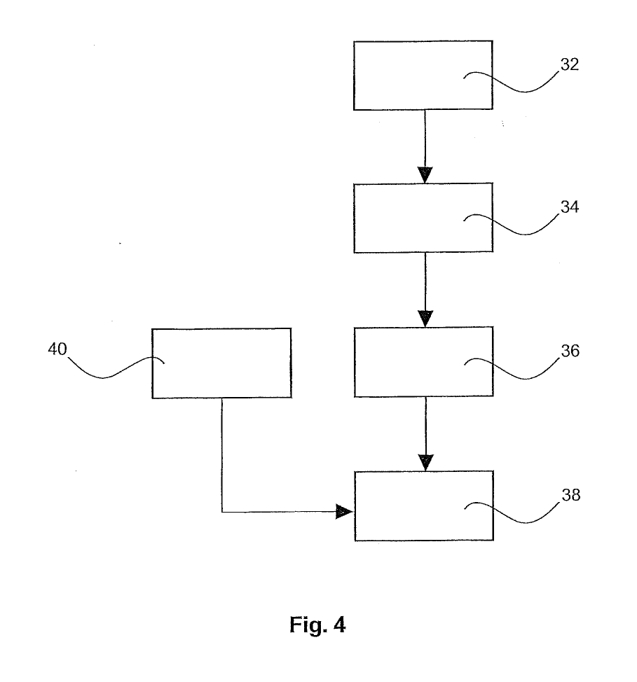

Furthermore, FIG. 4 shows a block diagram of a method according to an aspect of the invention, which method essentially comprises the steps of: extending 32 a towed device 4; measuring 34 a static air pressure; transmitting 36 the measured air pressure to a second communication device 24; and retracting 38 the towed device. Optionally, the method according to an aspect of the invention could also comprise transmitting 40 geometric altitude data.

In addition, it should be pointed out that “comprising” does not exclude other elements or steps, and “a” or “one” does not exclude a plural number. Furthermore, it should be pointed out that characteristics or steps which have been described with reference to one of the above exemplary embodiments can also be used in combination with other characteristics or steps of other exemplary embodiments described above. Reference characters in the claims are not to be interpreted as limitations.

### LIST OF REFERENCE CHARACTERS

2 Device
4 Towed device
5 Towed device
6 Linear retaining means
7 Towed device
8 Actuating device
9 Towed device
10 Enclosure
11 Towed device
12 Grouped arrangement
13 Towed device
14 Pressure sensor
16 Energy storage device
17 GPS receiver
18 First communication device
19 GPS antenna
20 Electronics unit
21 Antenna
22 Antenna
23 Solar cell
24 Second communication device
26 Regulating unit
28 Electronics device
30 Aircraft
32 Extend
34 Measure
36 Transmit
38 Retract
40 Transmit

1. An apparatus for measuring an air pressure, comprising:
a linear retaining means;
a towed device comprising an enclosure;
at least one pressure sensor for measuring a static air pressure; and
an actuating device configured to be positioned in an aircraft, for retracting and extending the linear retaining means;
wherein the towed device comprises an autarchic voltage supply and a wireless first communication device connected to the autarchic voltage supply, and
wherein the first communication device is configured to transmit at least one of signals and data representing acquired measurement data to a second communication device.

2. The apparatus of claim 1, wherein the actuating device comprises a winch, the winch being configured to retract or extend the linear retaining means.

3. The apparatus of claim 1, wherein the linear retaining means is comprises a nylon cable.

4. The apparatus of claim 3, wherein the synthetic cable comprises polyamide.

5. The apparatus of claim 1, wherein the linear retaining means comprises a wire cable.

6. The apparatus of claim 1, wherein the autarchic voltage supply is at least in part configured as an energy storage device.

7. The apparatus of claim 1, wherein the autarchic voltage supply is at least in part configured as a solar cell.

8. The apparatus of claim 1, further comprising a GPS receiver and a GPS antenna connected to the first communication device for transmitting a geographic altitude.

9. The apparatus of claim 1, comprising a plurality of pressure sensors arranged on the linear retaining means.

10. A system for acquiring air data, comprising an apparatus for measuring an air pressure, the apparatus comprising:
a linear retaining means;
a towed device comprising an enclosure;
at least one pressure sensor for measuring a static air pressure; and
an actuating device configured to be positioned in an aircraft, for retracting and extending the linear retaining means;
wherein the towed device comprises an autarchic voltage supply and a wireless first communication device connected to the autarchic voltage supply, and
wherein the first communication device is configured to transmit at least one of signals and data representing acquired measurement data to a second communication device; and
a second communication device configured for communicating with the first communication device and for transmitting at least one of signals and data representing acquired measurement data to an electronics device configured to be positioned in an aircraft.

11. A method for measuring a static air pressure, comprising the steps of
extending a towed device on a linear retaining means to the surroundings of an aircraft;
measuring a static air pressure by at least one pressure sensor at least on one of the towed device and the linear retaining means;
transmitting the measured air pressure by a wireless first communication device to a second communication device; and
retracting the towed device.

12. The method of claim 11, further comprising
transmitting geographic altitude data provided by a GPS receiver from the first communication device to the second communication device.

13. The method of claim 12, further comprising:
correlating a measured barometric altitude on an aircraft with the use of a geometric geographic altitude determined by the GPS receiver on the towed device and a geometric altitude determined in the aircraft at a reference point by a GPS receiver on board the aircraft.

14. An aircraft comprising at least one apparatus , the apparatus comprising:
a linear retaining means;
a towed device comprising an enclosure;
at least one pressure sensor for measuring a static air pressure; and
an actuating device configured to be positioned in an aircraft, for retracting and extending the linear retaining means;
wherein the towed device comprises an autarchic voltage supply and a wireless first communication device connected to the autarchic voltage supply, and
wherein the first communication device is configured to transmit at least one of signals and data representing acquired measurement data to a second communication device.

15. The aircraft of claim 14, wherein the apparatus is arranged in a vertical stabiliser of the aircraft, and the vertical stabiliser comprises an opening for feeding the linear retaining means from the vertical stabiliser to an airflow surrounding the aircraft.
